(19) United States
(12) Patent Application Publication
(10) Pub. No.: US 2008/0047280 A1
(43) Pub. Date: Feb. 28, 2008

(54) Heat recovery system

(75) Inventor: Christopher Alfred Timothy Dubar, Beaumaris (AU)

Correspondence Address: KOPPEL, PATRICK & HEYBL, 555 ST. CHARLES DRIVE, SUITE 107, THOUSAND OAKS, CA, 91360, US

(73) Assignee: BHP BILLITON LIMITED

(21) Appl. No.: 11/509,958

(22) Filed: Aug. 24, 2006

(51) Int. Cl. F17C 9/02

(52) U.S. Cl. 62/50.2

(57) ABSTRACT

A heat recovery system comprising: an LNG warmer; at least one item of equipment requiring cooling and thereby generating waste heat; a heat exchanger arranged to provide heat exchange between the LNG warmer and the waste heat, whereby said waste heat can be used to provide warming for the LNG; wherein said heat exchanger is a closed loop heat exchange means, whereby the heat exchange fluids in said heat exchanger are substantially retained within the heat exchanger during operation of the system. This enables the system to be operated offshore without needing to use the surrounding seawater to provide cooling for the waste heat from the equipment.

This invention relates to a heat recovery system. More particularly, the invention relates to an offshore heat recovery system which reduces or even substantially eliminates the need to use external seawater for cooling. The invention also relates to a method of warming Liquefied Natural Gas (LNG).

### BACKGROUND TO THE INVENTION

Offshore LNG import terminals are being considered in many coastal locations and the design for some of these facilities involves a Floating Storage and Regasification Unit (FSRU). Other regasification facilities have been proposed on fixed gravity based structures (GBS) or other offshore structures. The use of large quantities of seawater as a heat source for vaporisation of LNG has now been recognised as a problem in many locations due to the environmental effect of thermal discharges, chemical emissions and destruction of marine organisms. The use of submerged combustion vaporisers (SCV) or ambient air vaporisers are alternative regasification methods that can be used to reduce the very large amounts of seawater required. Facilities using these alternatives however, still need to generate electrical power to run the regasification process. These power generation facilities and other equipment still require a significant amount of cooling and this would normally be supplied from a standard marine system using seawater as the cooling medium. Due to the large power requirements for these facilities the amount of seawater required can still be significant and also raises environmental concerns due to the thermal and chemical discharges and destruction of fish larvae and eggs in the intake systems.

FIG. 1 shows a typical seawater cooling system that would be used on an FSRU design or other floating offshore structures. A similar design would also be used for facilities installed on a GBS or other fixed offshore structures.

Seawater (12) is taken up from a sea chest (50) structure installed in the hull, below the water level. The sea chest structure is designed with a low approach velocity and incorporates a coarse grill to prevent ingress of large foreign objects such as seaweed. On the inboard side of the sea chest a filter or strainer (51) is provided to prevent ingress of marine organisms and smaller solid particles. Seawater (13) is pumped from the sea chest by the seawater pumps (52) and may also be passed through a further fine filtration system (53) to remove solid material which would otherwise block the small cooling passages of the heat exchangers (55,56) in the cooling system. The strainer (51) and the filtration system (53) however will also capture any marine organisms, fish eggs and larvae that have un-intentionally been ingested in the seawater intakes (11).

A side stream (20) is taken from the discharge of the pumps and passed through a chlorine generator (54) which produces free chlorine by passing an electric current through the seawater. This stream is recycled back into the sea chest to disinfect the seawater and prevent growth of marine organisms in the cooling system which would otherwise limit the effectiveness of the heat exchangers (55,56).

The seawater stream (15) is then passed to the cooling system which consists of a number of heat exchangers (55,56) used to provide cooling for the power generation system (61) and other auxiliary equipment (62) such as the facility HVAC system, instrument air compressor aftercoolers, etc. The power generation system can consist of internal combustion engines, gas turbines or steam turbines and all will require some form of cooling. The cooling duty will depend on the type of power generators used; this can be significant for some types such as dual fuel diesel engines which have jacket water cooling systems and large charge air coolers.

The seawater stream (16) exits the cooling system at a temperature of up to 15° C. or more above the ambient water temperature and contains residual chlorine concentrations above the levels that some authorities permit: the distance required to disperse/degrade residual chlorine to acceptable levels is always a matter for debate and uncertainty. Some authorities also regulate the maximum temperature of cooling water discharges and to meet this requirement it is often necessary to increase the cooling water flowrates to limit the temperature rise in the cooling system. This increases the size and power requirements of the cooling water equipment and also will increase the amount of marine organisms ingested into the intake.

### SUMMARY OF THE INVENTION

We have now found a way to substantially reduce, or even eliminate, the use of seawater in the cooling of equipment that produces waste heat on offshore structures. The invention can be applied to systems for warming LNG that do not require the use of seawater from the external environment, such as the SCV systems described above, thereby providing an integrated heat recovery system that does not require the use of any substantial amounts of seawater from the environment.

Broadly, our invention involves using the waste heat from the equipment to warm the LNG. This involves using a closed loop heat exchange system in which substantially no seawater is taken into or discharged from the heat exchange system to the environment during operation thereof.

According to one aspect of the invention there is provided a heat recovery system comprising:
(i) an LNG warmer
(ii) an item of equipment generating waste heat
(iii) a heat exchanger arranged to provide heat exchange between the LNG warmer and the item of equipment, whereby said waste heat can be used to provide warming for the LNG,
wherein said heat exchanger is a closed loop heat exchanger, whereby the heat exchange fluids in said heat exchanger are substantially retained within the heat exchanger during operation of the system.

Thus, the system according to the invention makes it possible to warm the LNG and cool the item of equipment without the need to take any substantial quantity of seawater from the environment.

The item of equipment may be any item of equipment requiring cooling. There may be more than one item of equipment that is cooled using the system according to the invention. Thus, the item or items of equipment may be any of a large number of items of equipment, including, but not limited to power generators, HVAC (heating, ventilation and air conditioning) condensers, instrument air compressors, and aftercoolers.

We particularly prefer that the item of equipment requiring cooling includes at least one power generator. Preferably, at least part of the power generated by the power generator is used to operate the LNG warmer.

In a preferred embodiment, the means for warming the LNG comprises a means for regasifying or vaporising the LNG.

Preferably the means for warming the LNG (an “LNG warmer”) comprises a first heat exchanger comprising: a LNG inlet and outlet; a warming fluid inlet and outlet; and a warming section, in fluid communication with said inlets and outlets, in which said LNG can be warmed or regasified (vaporised) by heat exchange contact with said warming fluid.

Desirably, the system comprises further comprises a burner for heating the warming fluid prior to, and/or when, the water enters said vaporising section. The energy for operating the burner may be provided, in part, or entirely, by a power generator. The power generator may be the item of equipment to be cooled, or one of said items of equipment. Preferably, said warming section comprises a vessel defining a bath containing said warming fluid, and at least one conduit having a bore, sealed from the warming fluid, and extending within said bath, the or each conduit being adapted to convey LNG therethrough, whereby LNG being conveyed through the or each conduit can be heat exchanged with the warming fluid in the vessel.

In a first embodiment, the system further comprises a second heat exchanger adapted to provide heat exchange with the item of equipment producing waste heat, wherein said second heat exchanger comprises: an inlet and outlet for a coolant for said item of equipment; a warming fluid inlet and outlet; and a heat exchange section, in fluid communication with said inlets and outlets, in which said coolant can be cooled by heat exchange contact with said warming fluid.

In a second embodiment, system further comprises a second heat exchanger adapted to provide heat exchange with the item of equipment producing waste heat, wherein said second heat exchanger comprises: an inlet and outlet for a coolant for said item of equipment; an intermediate heat exchange fluid inlet and outlet; and a heat exchange section, in fluid communication with said inlets and outlets, in which said coolant can be cooled by heat exchange contact with said intermediate heat exchange fluid. In this embodiment, the system preferably further comprises a third heat exchanger, comprising: a warming fluid inlet and outlet; an intermediate heat exchange fluid inlet and outlet; and a heat exchange section, in fluid communication with said inlets and outlets, in which said intermediate heat exchange fluid can be cooled by heat exchange contact with said warming fluid.

In the above embodiments, the coolant is intended for heat exchange with the item of equipment, or part of the item of equipment, whereby the coolant absorbs at least part of the waste heat produced by said item of equipment.

In the embodiments described above the heat exchanger is a closed loop heat exchanger, whereby the heat exchange fluids circulate within the heat exchangers in a substantially closed loop. This means that the heat exchange fluids are not withdrawn from the system or added to the system, except to the small extent necessary to replace the fluid losses incurred during normal operation of the system. It is a particular feature of the invention that the system does not require, during normal operation, that any seawater is taken into, or discharged from, the heat exchangers of the heat exchange means, or any other part of the system to the environment.

Thus, the system according to the invention provides a significant advantage over the systems described in the prior art, in the amount of seawater used for cooling, or warming, can be substantially reduced, and preferably substantially eliminated.

According to another aspect of the invention, there is provided an offshore structure comprising a support, and a heat recovery system as described above.

The offshore structure may be a floating structure, such as, for example a ship or boat; or it may be a fixed platform. The offshore structure may be a fixed gravity based system. In an embodiment, the offshore structure is a FSRU.

The offshore structure may be any suitable structure adapted to be disposed in a marine environment. The structure may be adapted to be disposed a few metres from the shore, or several kilometres, or several hundred kilometres from the shore.

It is a feature of the invention that the offshore structure does not take need to take seawater from the surrounding environment, then heat or cool it and return the heated or cooled seawater to the surrounding environment.

According to another aspect of the invention there is provided a method of using the waste heat generated by an item of equipment on an offshore structure to warm LNG, wherein said waste heat is used to warm the LNG by a closed loop heat exchange system, in which substantially no seawater is taken into or discharged from the system to the environment.

According to another aspect of the invention there is provided a method of warming LNG, wherein said LNG is warmed by closed loop heat exchange with waste heat generated by at least one item of equipment, whereby substantially none of the heat exchange fluids are discharged to the external environment during operation of the method.

Preferably the LNG and a warming fluid are both passed through a heat exchanger in heat exchange relationship, whereby the LNG is warmed by the warming fluid and the warming fluid is cooled by the LNG.

In a first embodiment, a coolant for said item of equipment and the warming fluid are both passed through a second heat exchanger, in which the warming fluid is warmed by the coolant, and the coolant is cooled by the warming fluid.

In a second embodiment, a coolant for said item of equipment and an intermediate heat exchange fluid are preferably both passed through a second heat exchanger, in which the intermediate heat exchange fluid is warmed by the coolant, and the coolant is cooled by the intermediate heat exchange fluid. In the second embodiment, the warming fluid and the intermediate heat exchange fluid are preferably both passed through a third heat exchanger, in which the intermediate heat exchange fluid is cooled by the warming fluid, and the warming fluid is warmed by the intermediate heat exchange fluid.

In the above embodiments, the intermediate heat exchange fluid is preferably water, most preferably water with additives, such as corrosion inhibitors and/or glycols. If desired, the intermediate heat exchange fluid may include seawater, so that it can easily be replenished, when necessary.

In the above embodiments, the warming fluid is preferably water. If desired, the warming fluid may contain additives such as corrosion inhibitors and/or glycols.

It will be appreciated that in the above embodiments, there may be more than one intermediate heat exchange fluid. Thus, for example, a first heat exchange fluid may be warmed by the coolant, a second heat exchange fluid may be warmed by the first heat exchange fluid, and the warming fluid may be warmed by the second heat exchange fluid. Additional heat exchangers may be provided, depending on the number of heat exchange fluids that are used.

It will also be appreciated that in the above embodiments there may be more than one item of equipment generating waste heat. One, more than one, or all of such items of equipment may be included in the heat recovery system. When there is more than one such item of equipment, a series arrangement may be used, in which the warming fluid is sequentially placed in a heat exchange relationship (with or without one or more intermediate heat exchange fluids) with one item of equipment followed by another. In another embodiment, a parallel arrangement may be used, in which the warming fluid is split into a plurality of streams, and each stream is placed in a heat exchange relationship (with or without one or more intermediate heat exchange fluids) with a respective one of the items of equipment.

### BRIEF DESCRIPTION OF THE DRAWINGS

Reference is now made to the accompanying drawings, in which:

FIG. 1 shows a prior art seawater cooling system suitable for use with a FSRU;

FIG. 2 shows a first embodiment of a system according to the invention;

FIG. 3 shows a second embodiment of a system according to the invention;

FIG. 4 shows a third embodiment of a system according to the invention;

FIG. 5 shows a fourth embodiment of a system according to the invention;

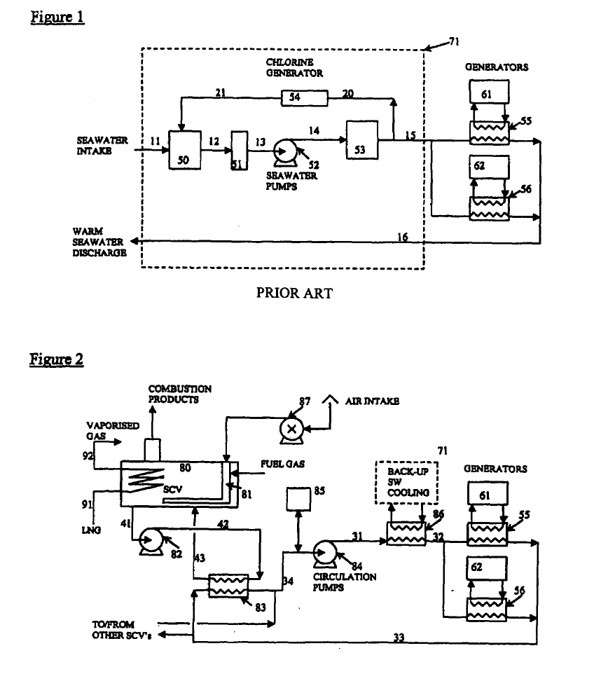

### DESCRIPTION OF THE PREFERRED EMBODIMENTS

LNG is pumped from storage (91) and passed through coils submerged in a water bath (80) and is vaporised by heat exchange with the water in the bath. The water in the bath is heated and agitated to ensure good heat transfer by the combustion gases produced in a submerged combustion burner (81). Air is supplied from a blower (87) and fuel is supplied from the boil-off gas from the LNG storage tanks and/or part of the vaporised LNG. The combustion products leave the water bath at close to the water bath temperature and so the process has a very high thermal efficiency although the use of vaporised gas (typically 1.5% of LNG throughput) incurs a high operating cost. The combustion products are also a source of greenhouse gases and contain some NOx pollutants.

In this invention the SCV water bath is used as a heat sink to provide cooling for the engine room generators and auxiliary equipment. The primary purpose of the invention is to eliminate the intake of cooling water during normal operation however an important benefit is that fuel gas usage is reduced in the SCV's with a corresponding reduction in atmospheric emissions. Other methods of reducing fuel usage for onshore SCV's have been disclosed whereby heat is recovered from gas turbine exhausts and integrated into the SCV water bath. This present invention is a significant improvement for offshore facilities as it eliminates cooling water usage where this is an environmental concern.

A description of the preferred embodiment of the invention follows (Refer to FIG. 2.)

A set of circulation pumps (84) circulates a cooling fluid which can be either fresh water, water/glycol solution or brine solution, with suitable corrosion inhibitors. It is possible for the cooling fluid to be seawater, but, if so, then substantially none of the fluid should be returned to the surrounding marine environment while it is above or below the ambient temperature. The cool fluid (32) at a temperature of between 7 and 32° C. is used in place of cold seawater to provide cooling for the power generation system (61) and other auxiliary equipment (62) such as the facility HVAC system, instrument air compressor aftercoolers, etc., in the FSRU machinery space below deck. The cooling fluid (33) leaves the cooling system at an elevated temperature of between 22 and 47° C. and is circulated up on deck where it is re-cooled in an exchanger (83) which uses a circuit of SCV water to transfer heat to the SCV water bath. Exchanger 83 can be any suitable exchanger such as a plate and frame, shell and tube or a printed circuit exchanger—a plate and frame exchanger is preferred in this application. The cooling fluid (34) then returns to the suction of the circulation pumps. As the cooling system is a closed circuit an expansion tank (85) is required to allow for fluid volume changes due to temperature changes.

The temperature in the SCV water bath will vary in the range 5 to 30° C. depending on the LNG throughput and control set point. A stream (41) is withdrawn from the SCV water bath at a suitable location and is circulated by the SCV circulation pump (82) through the other side of exchanger 83. The warmed SCV water (43) at a temperature of between 15 and 40° C. is returned to the SCV water bath at a suitable location and mixes with the SCV water heated by contact with the combustion gases. A baffle or baffle will be installed in the SCV to ensure that short circuiting of this warm water back to the pump inlet does not occur. The heating of the water by the cooling circuit in exchanger 83 adds heat into the SCV water bath and reduces the duty supplied by the SCV burner (81) and hence fuel required, in direct relation.

An FSRU with a typical capacity of 500 to 1500 MMscfd of gas will require multiple SCV's however it is not necessary to provide every SCV with a circulation pump (84) and an exchanger (83). Installing the cooling exchanger on 25% of the SCV's should provide sufficient flexibility to provide for SCV maintenance although this will also depend on the size of the cooling load as a proportion of the SCV heat duty.

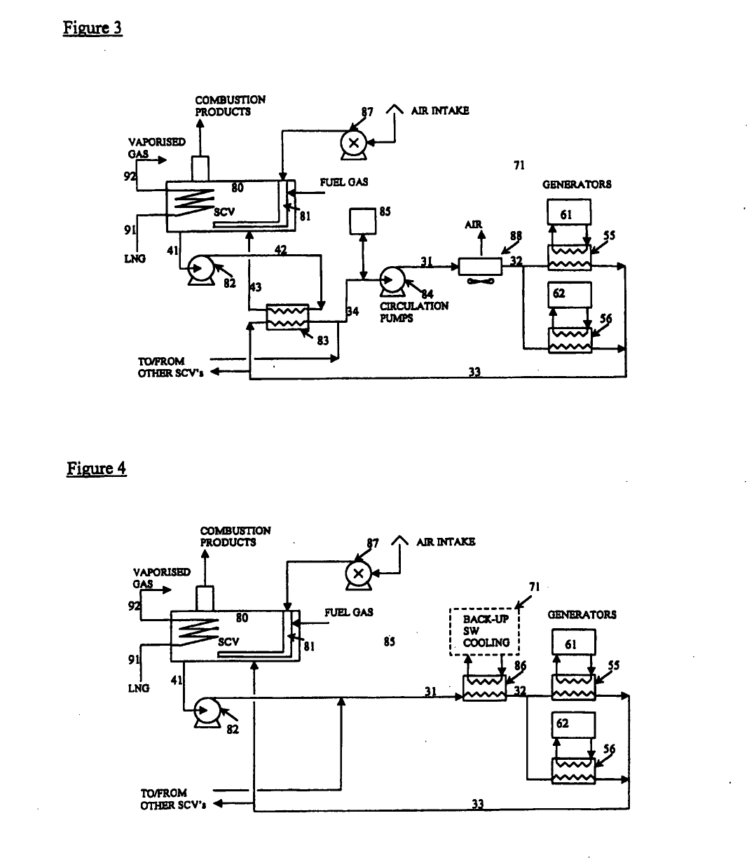

While the SCV's would be expected to be operational for the majority of time, a back-up cooling system will still be required to provide cooling for initial start-up and for occasions when gas cannot be produced. The preferred embodiment shown in FIG. 2 has a seawater system (71) as a back-up which cools the circulating fluid in exchanger 86 when required. The back-up seawater system would normally be isolated and filled with fresh water. Alternatively as shown in FIG. 3 the seawater back-up system (71) and exchanger (86) could be replaced with a bank of air coolers (88) located on deck to eliminate even this small back-up use of the seawater system.

FIG. 2 shows the use of a closed circuit to transfer heat between the generator cooling system and the SCV's. This has a number of advantages including segregating the SCV's on deck from the machinery space equipment below deck. In the unlikely event of a tube rupture in the SCV there would be no path for flammable gas to be routed into the machinery space and thus it eliminates the fire/explosion risk of the scheme.

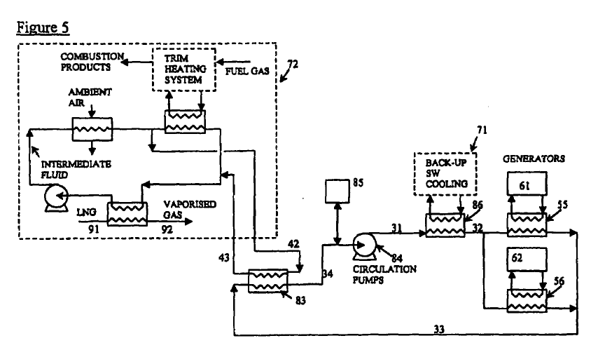

An alternative configuration would be to use the SCV circulation pumps (82) to circulate SCV water directly to the generator cooling system and thus eliminate equipment items 83,84 and 85 and associated piping. This is shown in FIG. 4. While this configuration will result in less equipment it is not preferred due to the small increase in fire/explosion risk in the machinery space in the event of a tube rupture in the SCV's. The SCV water is also corrosive due to CO2 and NOx components from the combustion products dissolving in the water and lowering the pH. While the pH can be controlled via the addition of soda ash or other alkali's it will require the pipework between the SCV's and machinery space to be of more expensive corrosion resistant materials.

The preferred embodiment shown in FIG. 2 uses SCV's to vaporise the LNG however the invention can also be integrated with other regasification methods such as those which use ambient air heating in conjunction with trim heating. The amount of heat that can be recovered from ambient air depends on the geographical location of the facility and the hourly and seasonal temperature variation. Most locations, other than in the tropics, will require supplemental trim heating of the LNG to make up for shortfall from the air when the temperature is too low. This supplemental heating will normally be provided by fired heaters burning fuel gas to heat a circulating water/glycol or brine fluid which is then used to vaporise LNG directly or is used to supplement heating of an intermediate fluid normally heated in ambient air heaters.

FIG. 5 shows an example of how the current invention can be integrated with an LNG regasification system using ambient air to vaporise the LNG, so that use of seawater for cooling of the generators and auxiliary equipment can still be eliminated. System 72 shows a possible regasification scheme using an intermediate circulating fluid to vaporise LNG, where this fluid is heated by heat exchange with ambient air and optionally a trim heating system, burning fuel gas to supply more heat when the ambient air temperature is too low. In this example of the invention, part of the circulating fluid is withdrawn as stream 42 at a temperature below ambient air temperature and used to cool stream 33 in heat exchanger 83. Stream 42 is preferably withdrawn from system 72 after the cold intermediate fluid has been re-heated with ambient air—the temperature at this location will be below the ambient air temperature and sufficiently low to cool stream 33 in heat exchanger 83. Stream 43 has now been warmed in exchanger 83 and is combined with heated intermediate fluid in system 72 prior to the LNG vaporiser.

Whenever the ambient air temperature is too cold and supplemental heating is required in system 72, the heat supplied by stream 43 reduces the duty of the trim heating system in direct relation with cooling duty of the generators and auxiliary equipment and hence reduces fuel usage and emissions from the trim heating system. If the ambient air temperature provides enough heating without the trim heating system in operation then the effect will be to increase the temperature of the intermediate fluid leaving the LNG vaporiser and reducing the operational load on the ambient air heater.

FIG. 5 shows one example of a regasification process using ambient air but there are many other variations which could be considered. In principle the current invention can be integrated with all these variations so that the regasification process provides a heat sink for the cooling of the engine room generators and auxiliary equipment on an LNG FSRU and hence eliminates seawater usage during normal operation.

Another variation is a regasification system in which all of the heat is supplied by fired heaters heating a water/glycol fluid which is then used to vaporise the LNG or heat another intermediate stream which vaporises LNG. This is similar to the embodiment of FIG. 5 without the ambient air cooler.

It will be appreciated that the invention described above may be modified.

1. A heat recovery system comprising:
(i) an LNG warmer
(ii) an item of equipment generating waste heat
(iii) a heat exchanger arranged to provide heat exchange between the LNG warmer and the item of equipment, whereby said waste heat can be used to provide warming for the LNG,
wherein said heat exchanger is a closed loop heat exchange means, whereby the warming fluid in said heat exchanger is substantially retained within the heat exchanger during operation of the system.

2. A system according to claim 1, wherein the LNG warmer comprises a means for regasifying or vaporising the LNG.

3. A system according to claim 1, wherein the LNG warmer comprises a first heat exchanger comprising: a LNG inlet and outlet; a warming fluid inlet and outlet; and a warming section, in fluid communication with said inlets and outlets, in which said LNG can be warmed by heat exchange contact with said warming fluid.

4. A system according to claim 3, further comprising a burner for heating the warming fluid prior to, and/or when, the water enters said warming section.

5. A system according to claim 4, wherein said warming section comprises a vessel defining a bath containing said warming fluid, and at least one conduit having a bore, sealed from the warming fluid, and extending within said bath, the at least one conduit being adapted to convey LNG therethrough, whereby LNG being conveyed through the at least one conduit can be heat exchanged with the warming fluid in the vessel.

6. A system according to claim 1, further comprising a second heat exchanger adapted to provide heat exchange with the item of equipment producing waste heat, wherein said second heat exchanger comprises: an inlet and outlet for a coolant for said item of equipment; a warming fluid inlet and outlet; and a heat exchange section, in fluid communication with said inlets and outlets, in which said coolant can be cooled by heat exchange contact with said warming fluid.

7. A system according to claim 1, further comprising a second heat exchanger adapted to provide heat exchange with the item of equipment producing waste heat, wherein said second heat exchanger comprises: an inlet and outlet for a coolant for said item of equipment; an intermediate heat exchange fluid inlet and outlet; and a heat exchange section, in fluid communication with said inlets and outlets, in which said coolant can be cooled by heat exchange contact with said intermediate heat exchange fluid.

8. A system according to claim 7, further comprising a third heat exchanger, comprising: a warming fluid inlet and outlet; an intermediate heat exchange fluid inlet and outlet; and a heat exchange section, in fluid communication with said inlets and outlets, in which said intermediate heat exchange fluid can be cooled by heat exchange contact with said warming fluid.

9. A system according to claim 1, wherein the item of equipment comprises a power generator and a HVAC condenser.

10. A system according to claim 9, further comprising a cooler selected from the group consisting of an instrument air compressor and after cooler.

11. A system according to claim 1, wherein the item of equipment includes at least one power generator, and at least part of the power generated by the power generator is used to operate the LNG warmer.

12. A system according to claim 1, comprising a plurality of said items of equipment.

13. An offshore system, comprising
(i) an LNG warmer
(ii) an item of equipment generating waste heat
(iii) a heat exchanger to provide heat exchange between the LNG warmer and the item of equipment, whereby said waste heat can be used to provide warming for the LNG
(iv) a support to support said LNG warmer, said item of equipment and said heat exchanger,
wherein said first heat exchanger is a closed loop heat exchanger whereby the warming fluid in said heat exchanger is substantially returned within the heat exchanger during operation of the system.

14. A system according to claim 13, wherein said support comprises a floating structure.

15. A system according to claim 13, wherein said support comprises a fixed platform.

16. A method of using the waste heat generated by an item of equipment on an offshore structure to warm LNG, wherein said waste heat is used to warm the LNG by a closed loop heat exchange system, in which substantially no seawater is taken into or discharged from the system.

17. A method of warming LNG, wherein said LNG is warmed by closed loop heat exchange with waste heat generated by at least one item of equipment, whereby substantially none of the heat exchange fluids are discharged to the external environment during operation of the method.

18. A method according to claim 17, wherein the LNG and a warming fluid are both passed through a heat exchanger in heat exchange relationship, whereby the LNG is warmed by the warming fluid and the warming fluid is cooled by the LNG.

19. A method according to claim 18, wherein a coolant for said item of equipment and the warming fluid are both passed through a second heat exchanger, in which the warming fluid is warmed by the coolant, and the coolant is cooled by the warming fluid.

20. A method according to claim 18, wherein the warming fluid is water.

21. A method according to claim 18, wherein a coolant for said item of equipment and an intermediate heat exchange fluid are both passed through a second heat exchanger, in which the intermediate heat exchange fluid is warmed by the coolant, and the coolant is cooled by the intermediate heat exchange fluid.

22. A method according to claim 21, wherein, the warming fluid and the intermediate heat exchange fluid are both passed through a third heat exchanger, in which the intermediate heat exchange fluid is cooled by the warming fluid, and the warming fluid is warmed by the intermediate heat exchange fluid.

23. A method according to claim 21, wherein the intermediate heat exchange fluid is water.
